(19) United States
(12) Patent Application Publication
(10) Pub. No.: US 2014/0379244 A1
(43) Pub. Date: Dec. 25, 2014

(54) AVOIDANCE MANEUVER ASSISTANT FOR MOTOR VEHICLES

(71) Applicant: Thomas HAEUSSLER, Kuenzelsau-Vogelsberg (DE)

(72) Inventor: Thomas HAEUSSLER, Kuenzelsau-Vogelsberg (DE)

(73) Assignee: ROBERT BOSCH GMBH, Stuttgart (DE)

(21) Appl. No.: 14/304,468

(22) Filed: Jun. 13, 2014

(30) Foreign Application Priority Data
Jun. 20, 2013 (DE) 10 2013 211 645.4

(51) Int. Cl. G08G 1/16; B60W 50/00

(52) U.S. Cl. CPC G08G 1/16; B60W 50/0098; B60W 2050/0012
USPC 701/117

(57) ABSTRACT

An avoidance maneuver assistant for a motor vehicle includes: a sensory system for monitoring the traffic environment of the vehicle; and an electronic control device, in which an emergency avoidance function is implemented. The emergency avoidance function checks, using sensory data, if an emergency avoidance maneuver is necessary, and then intervenes in the dynamics of the vehicle via an actuator system, using an intervention force varying within predefined limits, to assist in the emergency avoidance maneuver. The control device implements a limiting function, which varies the limits for the intervention force as a function of a difference between actual dynamics determined by actions of the driver and setpoint dynamics determined by the emergency avoidance function.

### BACKGROUND OF THE INVENTION

1. Field of the Invention

The present invention relates to an avoidance maneuver assistant for motor vehicles, including a sensory system for monitoring the traffic environment of the vehicle and an electronic control device, in which an emergency avoidance function is implemented; the emergency avoidance function checking, using data supplied by the sensory system, if an emergency avoidance maneuver is necessary, and then acting upon the dynamics of the vehicle via an actuator system, using an intervention force varying within predefined limits, in order to assist the driver in executing the emergency avoidance maneuver.

2. Description of the Related Art

In vehicles of recent generations, assistance functions are available, which assess the risk situation of rear-end collisions and actively perform interventions via the brake system, in order to prevent accidents in this manner or at least reduce the severity of the accident. These assistance functions are only active when the driver does not initiate any avoidance maneuver for preventing the accident.

Assistance functions, which assist the driver during an emergency avoidance maneuver by intervening in the steering system, are also known. For reasons of safety, these avoidance functions (avoidance maneuver assistants) must be able to be overridden by the driver at any time. The overriding may be necessary, for example, when the driver wishes to take an avoidance trajectory other than that proposed by the function, due to a curve situation. Another example is a situation, in which the driver recognizes that an oncoming vehicle is approaching on the avoidance path and he or she therefore aborts the avoidance maneuver.

### BRIEF SUMMARY OF THE INVENTION

The object of the present invention is to provide an avoidance maneuver assistant having improved safety functions.

This object is achieved by implementing a limiting function in the control device, the limiting function varying the limits for the intervention force as a function of a difference between actual dynamics of the vehicle determined by actions of the driver and setpoint dynamics determined by an emergency avoidance function.

The limiting function of the present invention makes it easier for the driver to override the actions of the emergency avoidance function and to carry out his or her own intentions, when these deviate from the planning of the emergency avoidance function. In this manner, it is made easier for the driver to control the risk situation.

In one advantageous specific embodiment, an intention of the driver differing from the emergency avoidance function is recognized when the actual value of a variable characterizing the steering intervention, for example, the steering wheel angular velocity, has an algebraic sign different from the setpoint value of this variable determined by the emergency avoidance function. This criterion allows robust detection of a differing driver intention in the sense that, in the cases in which the driver overreacts to the effect that the actual value differs from the setpoint value but has the same algebraic sign, this is not falsely interpreted as a different driver intention.

In the following, an exemplary embodiment is explained in more detail in view of the drawing.

### BRIEF DESCRIPTION OF THE DRAWINGS

FIG. 1 shows a block diagram of an avoidance maneuver assistant according to the present invention.

FIG. 2 shows a diagram of a traffic situation, in order to explain the method of functioning of the avoidance maneuver assistant.

FIG. 3 shows a graph, in which the steering wheel angular velocity is represented as a function of time for the traffic situation shown in FIG. 2.

FIG. 4 shows a force versus time graph for FIG. 3.

FIG. 5 shows a diagram of another example of a traffic situation.

FIG. 6 shows a graph, in which the steering wheel angular velocity is represented as a function of time for the traffic situation shown in FIG. 5.

FIG. 7 shows a force versus time graph for FIG. 6.

### DETAILED DESCRIPTION OF THE INVENTION

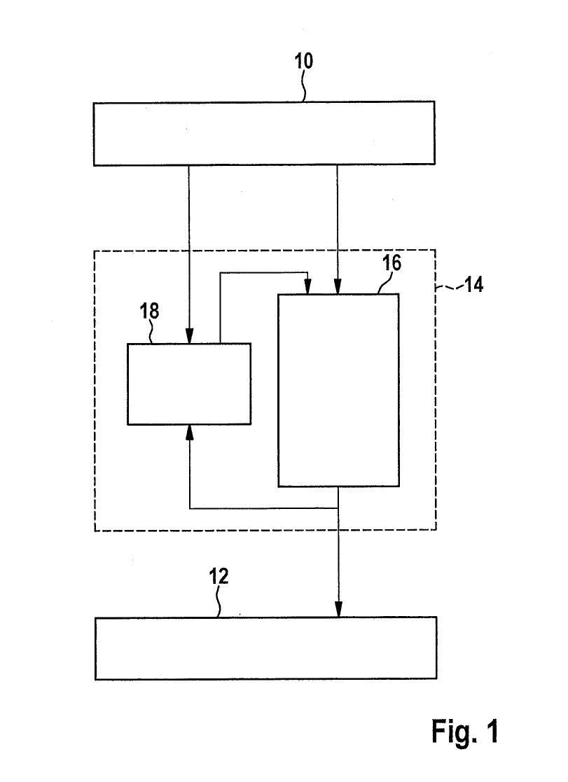

The avoidance maneuver assistant represented in FIG. 1 as a block diagram includes a sensory system 10, an actuator system 12, and an electronic control device 14, for example, in the form of one or more microprocessors, which evaluates and processes the data supplied by sensory system 10 and outputs commands to actuator system 12 as a result of this processing.

On one hand, sensory system 10 includes sensor components, which monitor the dynamic state of the reference vehicle, thus, e.g., its velocity, acceleration, steering wheel angular velocity, yaw rate, transmission state, slip of the driven wheels and the like. In addition, sensory system 10 includes sensor components, which monitor the environment of the vehicle, for example, video systems including associated electronic image processing, radar sensors, ultrasonic sensors and the like. In a broader sense, information sources, which provide, in a different manner, information about the traffic environment and, in particular, the traffic infrastructure, for example, data of a navigation system or stored maps, may also be included in sensory system 10.

An emergency avoidance function 16, which analyzes the current traffic situation and calculates, in a known manner, a probability of the occurrence of a collision with another vehicle or other obstacle, using the data supplied by sensory system 10, is implemented in control device 14. If this probability reaches a particular value, emergency avoidance function 16 outputs commands to actuator system 12, in order to initiate an emergency avoidance maneuver, e.g., initially, via appropriate instructions to the driver, but in the case of an emergency, by actively intervening in the dynamics of the vehicle, as well.

Accordingly, actuator system 12 includes devices for active intervention in the steering system, the drive system and/or the brake system of the reference vehicle. In this example, in particular, interventions in the steering system are considered.

A limiting function 18 is also implemented in control device 14; for its part, the limiting function evaluating data that are supplied by sensory system 10 and comparing interventions currently induced or planned by emergency avoidance function 16 with interventions, which the driver manually undertakes while overriding the avoidance maneuver assistant. If the result of this comparison is that the difference between the intervention actually undertaken by the driver and the intervention planned by the emergency avoidance function satisfies particular criteria that indicate that the driver does not want to carry out the avoidance maneuver proposed by emergency avoidance function 16 or, at any rate, not in the manner suggested, then the interventions in the driving dynamics provided by the emergency avoidance function are reduced and/or completely eliminated.

The force with which the emergency avoidance function actively intervenes in the steering system of the vehicle is normally limited in such a manner, that it is not able to exceed certain limits. These limits, which typically correspond to a steering-wheel torque of ±3 Nm, are selected to allow the driver to override the emergency avoidance function by acting upon the steering system himself or herself, using a larger force. To be sure, the emergency avoidance function will then put up a certain resistance to the actions of the driver, but the driver may overcome this resistance.

If limiting function 18 detects that the driver is pursuing a different intention, then the limits of the force via which the emergency avoidance function may act upon the system are reduced, so that the driver may overcome this system more easily. In the extreme case, the limits of the force are reduced to zero, that is, the emergency avoidance maneuver is completely aborted, which means that the driver alone obtains control over the vehicle.

In the following, the mode of operation of limiting function 18 shall be explained in greater detail in light of two example situations.

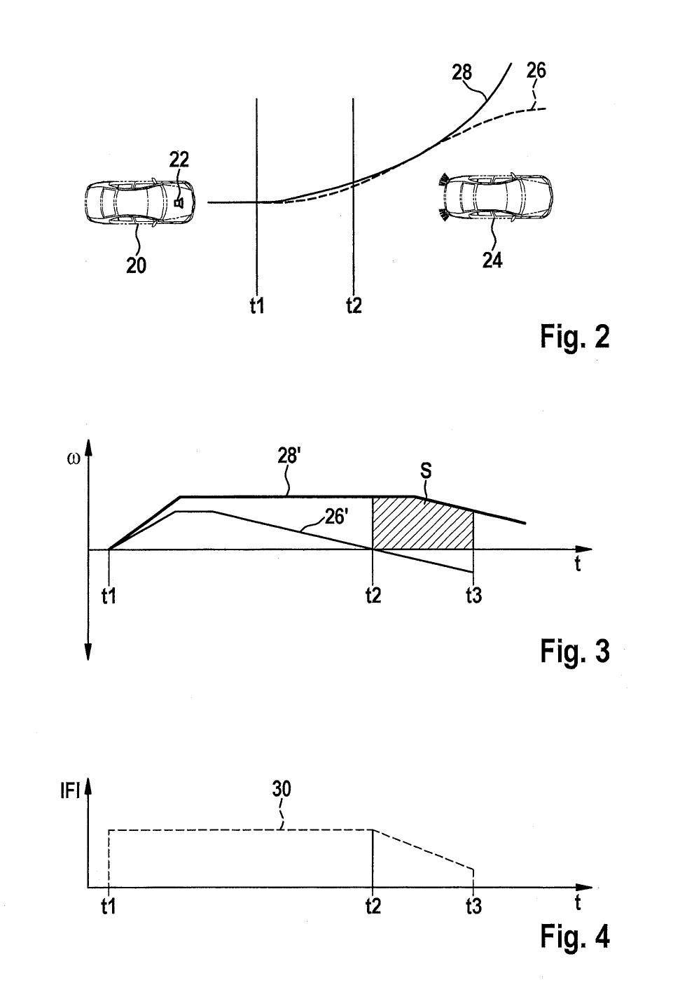

Schematically represented in FIG. 2 is a traffic situation, in which a vehicle 20 that is equipped with the avoidance maneuver assistant of the present invention (symbolized in the drawing by drawing in a radar sensor 22 in the vehicle) approaches an obstacle, in this example, a vehicle 24 stopped or braking hard in the lane of the reference vehicle. In the following, the vehicle 20 equipped with the avoidance maneuver assistant shall be referred to as the “reference vehicle.”

In light of the values of the distance and the relative speed of vehicle 24 measured by radar sensor 22, the avoidance maneuver assistant discerns that a collision would occur if the driver of the reference vehicle were not to undertake an avoidance maneuver. In response, emergency avoidance function 16 calculates setpoint dynamics 26 in the form of an avoidance trajectory, on which the obstacle may be safely driven around. Regardless of whether or not the driver of vehicle 20 becomes active of his or her own accord, emergency avoidance function 16 then actively intervenes in the vehicle steering system and makes an adjustment to the steering angle, which causes the vehicle to travel according to setpoint dynamics 26 if the intervention is not overridden by the driver. However, the force with which the automatic system intervenes in the steering system is limited in both directions to values, which correspond to a steering torque of, for example, ±3 Nm. If the driver, on his or her part, exerts a force on the steering wheel, the intervention force of the avoidance maneuver assistant is controlled in such a manner, that vehicle 20 nevertheless follows the calculated trajectory. However, if the driver exerts a torque on the steering wheel, which exceeds the limit of ±3 Nm, then the emergency avoidance function may no longer offset this intervention completely, which means that the course of the vehicle will deviate from setpoint dynamics 26.

In the example shown in FIG. 2, the driver obtains, by force, the actual dynamics 28 which correspond to a different avoidance trajectory of the vehicle. One reason could be, for example, that the driver recognizes (unlike the sensory system 10 of the vehicle, or earlier than it) that the roadway curves to the left, so that the driver must override the emergency avoidance function in order to keep the vehicle on the road.

In the example shown in FIG. 2, emergency avoidance function 16 becomes active at a time t1. Approximately at the same time, the driver also initiates an avoidance maneuver of his or her own accord. In a time interval between t1 and a later time t2, the differences between setpoint dynamics 26 and actual dynamics 28 are only small, and the two steering interventions correspond to a steering angle in the same direction. However, at time t2, emergency avoidance function 16 would turn the steering wheel in the opposite direction (to the right), in order to allow the vehicle to arrange itself in the passing lane. However, the driver continues to adjust the steering angle to the left, so that the vehicle moves in accordance with actual dynamics 28 and follows the left-hand curve of the roadway.

In FIG. 3, the same situation is represented in a graph, in which steering wheel angular velocity ω is plotted versus time t. A curve 26′ indicates the setpoint steering wheel angular velocity, which is calculated by the emergency avoidance function and corresponds to setpoint dynamics 26, while the steering wheel angular velocity corresponding to actual dynamics 28 is indicated by a curve 28′. As of time t1, the two curves initially increase and then remain at the same level, that is, the steering wheel is then turned to the left at a constant steering wheel angular velocity.

However, according to setpoint dynamics 26, the steering wheel angular velocity immediately decreases again and reaches a value of zero at time t2. At this time, the setpoint steering wheel angular velocity indicated by curve 26′ changes sign, and the countersteering motion to the right begins. On the other hand, the actual steering wheel angular velocity is traced by curve 28′. Subsequently, the steering wheel angular velocity, which corresponds to a steering angle to the left, remains constant for a considerably longer time and only begins to decrease again at a much later time.

Thus, the setpoint steering wheel angular velocity and the actual steering wheel angular velocity have opposite signs as of time t2. From this, limiting function 18 recognizes that the intention of the driver does not correspond to the setpoint dynamics 24 calculated by the avoidance maneuver assistant. From this moment on, the magnitude of the actual steering wheel angular velocity (curve 28′) is integrated with respect to time. Integral S is represented in FIG. 3 as a hatched surface. In this context, it is advantageous when the more heavily the actual steering wheel angular velocity is weighted, the longer the state, in which the setpoint and actual steering wheel angular velocities have opposite signs, continues. Then, the integrand that yields integral S would not be the function ω(t), but rather a function k(t−t2)ω, having an appropriately selected constant k.

The value of integral S determines how sharply the intervention force of the avoidance maneuver assistant is limited.

In FIG. 4, a curve 30 indicates a limit, which the magnitude |F| of the intervention force F exerted by the avoidance maneuver assistant on the steering system may not exceed. Prior to time t1, this limit has a value of 0, that is, emergency avoidance function 16 is not active. At time t1, the emergency avoidance function is activated, and the limit traced by curve 30 then has the above-mentioned standard value of, for example, 3 Nm. As of time t2, limiting function 18 then causes the limit to be reduced, namely, in a manner proportional to the instantaneous value of integral S. When this integral S finally exceeds a predefined threshold value, then emergency avoidance function 16 is completely deactivated, that is, the limit is reduced again to 0. Consequently, the emergency avoidance maneuver is aborted, which means that the driver alone has control over the vehicle. In the example shown in FIGS. 3 and 4, this occurs at a time t3.

Optionally, as of time t3, thus, as soon as integral S exceeds the threshold value, the limit may also be reduced to zero according to a (rapidly) decreasing curve, so that the driver does not feel an irritating jerk in the steering wheel in response to deactivation of the emergency avoidance function. As an option, constant k in the above-mentioned integrand may also be selected so that curve 30 decreases so rapidly, that it already reaches a value of 0 at time t3.

In the example described here, actual steering wheel angular velocity ω is integrated. In another specific embodiment, the difference between the actual and setpoint steering wheel angular velocities could also be integrated. Integral

S would then correspond to the area, which is enclosed between the two curves 26′ and 28′. Optionally, the integrand could also be formed by some other function of the actual and setpoint steering wheel angular velocities.

In another specific embodiment, it would also be conceivable to characterize the steering intervention, using a variable different from steering wheel angular velocity ω, such as the steering wheel angular acceleration or the steering wheel torque. The criterion that indicates a different intention of the driver would then be that the setpoint and actual steering wheel angular accelerations or steering wheel torques have opposite signs.

In principle, it would also be possible to evaluate the steering wheel angle directly instead of the steering wheel angular velocity. In this case, however, in the example situation illustrated in FIG. 2, the different intention of the driver would not be recognized until a later time, namely, when vehicle 20 reaches the position, at which the trajectory corresponding to setpoint dynamics 26 has its point of inflection and the steering wheel is consequently turned to the right. In contrast, the analysis of the steering wheel angular velocity or, alternatively, the steering wheel angular acceleration or the steering wheel torque has the advantage that the system reacts “more predictively.”

Alternatively, limiting function 18 may also evaluate a combination of several variables (e.g., steering wheel angular velocity and steering wheel torque), which are characteristic of the intensity of the steering intervention. The criterion for the intention of the driver would then be that the setpoint and actual values of a weighted sum of these variables have opposite signs. Accordingly, integral S would also be calculated by integrating a function, which is dependent on the actual values (and, if indicated, the setpoint values, as well) of the steering wheel angular velocity and the steering wheel torque.

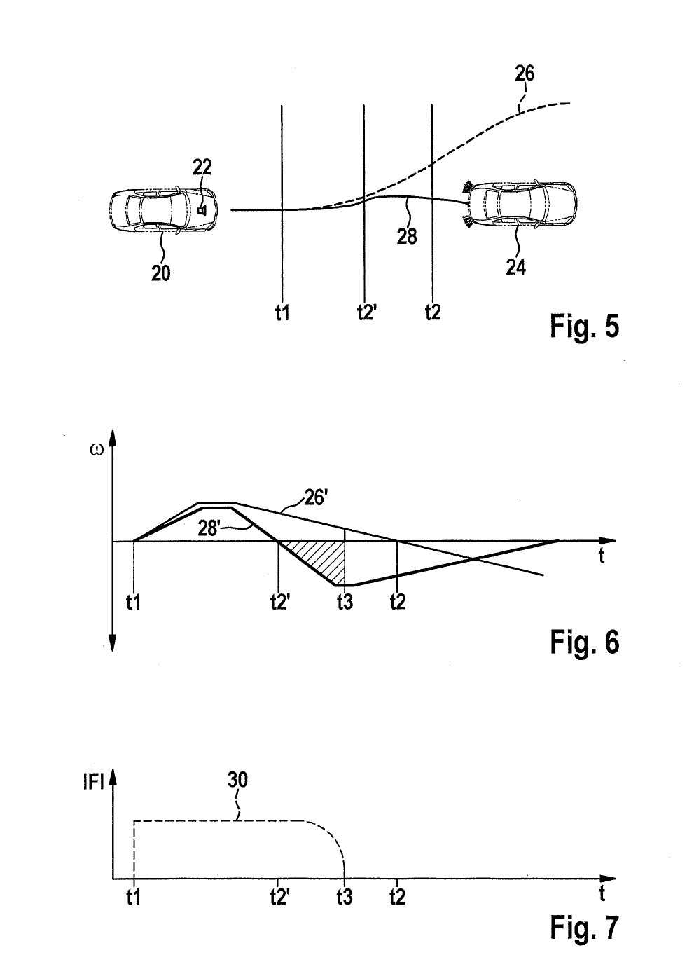

FIG. 5 illustrates another example situation, in which reference vehicle 20 is traveling on a road having only one lane for each direction of travel. When emergency avoidance function 18 initiates the avoidance maneuver, the driver recognizes that a vehicle is approaching in the oncoming lane, and he or she therefore aborts the avoidance maneuver and would rather accept a collision with the vehicle 24 that is stopped or traveling in the same direction. Therefore, in FIG. 5, actual dynamics 28 correspond to a trajectory, which remains in the reference lane and leads to the tail end of vehicle 24.

Curves 26′ and 28′ in FIG. 6 and curve 30 in FIG. 7 have the same meanings as the corresponding curves in FIGS. 3 and 4, but relate to the situation shown in FIG. 5. In this case, the actual steering wheel angular velocity indicated by curve 28′ already changes sign at a time t2′, which is clearly before the time t2 at which the setpoint steering wheel angular velocity (curve 26′) would also change sign. Thus, in this case as well, there is a phase in which the setpoint and actual steering wheel angular velocities have opposite signs and, therefore, the limits for intervention force F according to curve 30 in FIG. 7 are reduced. Here, the time t3, at which the emergency avoidance function is completely deactivated, is already before the time t2, at which the setpoint steering wheel angular velocity would also change sign.

In another specific embodiment, a different driver intention could also be detected, when the setpoint value and the actual value of the characteristic variable (in this case, steering wheel angular velocity ω) have the same sign, but differ by more than a particular threshold value or differ by more than this threshold value for longer than a predefined time span. However, the criterion proposed here, which focuses on opposite algebraic signs of the setpoint and actual values, has the advantage that overreactions of the driver, which do differ markedly from the setpoint dynamics but go in the same direction, are not interpreted as a different driver intention. In this manner, the driver is prevented from unintentionally deactivating the avoidance maneuver assistant due to such an overreaction.

What is claimed is:

1. An avoidance maneuver assistant unit for a motor vehicle, comprising:
a sensory system for monitoring a traffic environment of the vehicle; and
an electronic control device implementing an emergency avoidance function which (i) checks, using data supplied by the sensory system, whether an emergency avoidance maneuver by the motor vehicle is necessary, and (ii) if the emergency avoidance maneuver is necessary, intervenes in dynamics of the vehicle via an actuator system using an intervention force varying within predefined limits, in order to assist a driver of the motor vehicle in performing the emergency avoidance maneuver, wherein the control device implements a limiting function which varies the limits for the intervention force as a function of a difference between actual dynamics determined by actions of the driver and setpoint dynamics determined by the emergency avoidance function.

2. The avoidance maneuver assistant unit as recited in claim 1, wherein the limiting function compares setpoint and actual values of at least one variable which is characteristic of an intensity of an intervention in a steering system of the vehicle.

3. The avoidance maneuver assistant unit as recited in claim 2, wherein the limiting function reduces the limits for the intervention force at a point in time as of which the setpoint value and the actual value of the characteristic variable have opposite algebraic signs.

4. The avoidance maneuver assistant unit as recited in claim 2, wherein the limiting function reduces the limits for the intervention force in proportion to a selected variable which is a function of (i) the actual value of the characteristic variable and (ii) time.

5. The avoidance maneuver assistant unit as recited in claim 4, wherein the selected variable is a time integral.

6. The avoidance maneuver assistant unit as recited in claim 5, wherein the integrand of the time integral is proportional to the time.

7. The avoidance maneuver assistant unit as recited in claim 4, wherein the limiting function completely deactivates the emergency avoidance function when the selected variable exceeds a predefined threshold value.
